(19) United States
(12) Patent Application Publication
(10) Pub. No.: US 2013/0086112 A1
(43) Pub. Date: Apr. 4, 2013

(54) IMAGE BROWSING SYSTEM AND METHOD FOR A DIGITAL CONTENT PLATFORM

(71) Applicants: James R. Everingham, Santa Cruz, CA (US); Chris Waterson, Incline Village, NV (US)

(72) Inventors: James R. Everingham, Santa Cruz, CA (US); Chris Waterson, Incline Village, NV (US)

(21) Appl. No.: 13/252,053

(22) Filed: Oct. 3, 2011

(51) Int. Cl. G06F 17/30

(52) U.S. Cl. 707/780; 707/E17.02

(57) ABSTRACT

Systems and methods for presenting and/or browsing images on a digital content platform. In one embodiment, for example, there is provided an image-browsing system, including: (1) a database having a plurality of images; (2) an image frame provided on the digital content platform, wherein the image frame displays a first image from the database; and (3) a user-actionable interface, wherein activation of the interface replaces the first image within the frame with a second image. Various alternative aspects and embodiments are further described herein. For example, in certain instances, such systems and methods may be used to browse images on a digital content platform (e.g., a web page), conduct image searches directly from an image frame within a digital content platform, and/or provide contextually relevant advertising on the digital content platform.

### CROSS-REFERENCE TO RELATED APPLICATIONS

Except for any term definitions that conflict with the term definitions provided herein, the following related, co-owned, and co-pending applications are incorporated by reference in their entirety: U.S. patent application Ser. Nos. 12/902,066; 13/005,217; 13/005,226; 13/045,426; 29/387,270; 29/387,271; 29/387,272; 29/387,273; 13/151,110; and 13/219,460.

### SUMMARY

Disclosed herein are systems and methods for presenting and/or browsing images on a digital content platform. In one embodiment, for example, there is provided an image-browsing system, including: (1) a database having a plurality of images; (2) an image frame provided on a digital content platform, wherein the image frame displays a first image from the database; and (3) a user-actionable interface, wherein activation of the interface replaces the first image within the frame with a second image. Various alternative aspects and embodiments are further described herein. For example, in certain instances, such systems and methods may be used to browse images on a digital content platform (e.g., a web page), conduct image searches directly from an image frame within the digital content platform, and/or provide contextually relevant advertising on the digital content platform.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 is a high-level diagram illustrating an embodiment of the present invention.

FIG. 2 is a high-level diagram illustrating another embodiment of the present invention.

FIG. 3 is a high-level diagram illustrating yet another embodiment of the present invention.

FIG. 4 is a screen-shot of a web-based system in accordance with one embodiment presented.

FIG. 5 is a screen-shot of another embodiment presented.

FIG. 6 is a screen-shot of another embodiment presented.

FIG. 7 is a screen-shot of another embodiment presented.

FIG. 8 is a screen-shot of another embodiment presented.

FIG. 9 is a screen-shot of another embodiment presented.

FIG. 10 is a screen-shot of another embodiment presented.

FIG. 11 is a screen-shot of another embodiment presented.

FIG. 12 is a screen-shot of another embodiment presented.

FIG. 13 is a screen-shot of another embodiment presented.

FIG. 14 is a screen-shot of another embodiment presented.

FIG. 15 is a schematic drawing of a computer system used to implement the methods.

### DEFINITIONS

Prior to describing the present invention in detail, it is useful to provide definitions for key terms and concepts used herein. Unless defined otherwise, all technical and scientific terms used herein have the same meaning as commonly understood by one of ordinary skill in the art to which this invention belongs.

Contextual Information or Contextual Tag: data related to the contents and/or context of digital content (e.g., an image, or content within the image); for example, but not limited to, a description, identification, index, or name of an image, or object, or scene, or person, or abstraction within the digital content (e.g., image).

Contextually Relevant Advertisement: A targeted advertisement that is considered relevant to the contents and/or context of digital content on a digital content platform.

Crowdsource Network: One or more individuals, whether human or computer, used for a crowdsourcing application.

Crowdsourcing: The process of delegating a task to one or more individuals, with or without compensation.

Digital content: broadly interpreted to include, without exclusion, any content available on a digital content platform, such as images, videos, text, audio, and any combinations and equivalents thereof.

Digital content platform: broadly interpreted to include, without exclusion, any web page, website, browser-based web application, software application, mobile device application (e.g., phone or tablet application), TV widget, and equivalents thereof.

Image: a visual representation of an object, or scene, or person, or abstraction, in the form of a machine-readable and/or machine-storable work product (e.g., one or more computer files storing a digital image, a browser-readable or displayable image file, etc.). As used herein, the term “image” is merely one example of “digital content.”

Merchant: Seller or provider of a product or service; agent representing a seller or provider; or any third-party charged with preparing and/or providing digital content associated with a product or service. For example, the term merchant should be construed broadly enough to include an ad agency, or other intermediaries, charged with developing a digital content to advertise a product or service.

Proximate: is intended to broadly mean “relatively adjacent, close, or near,” as would be understood by one of skill in the art. The term “proximate” should not be narrowly construed to require an absolute position or abutment. For example, “content displayed proximate to an image,” means “content displayed relatively near an image, but not necessarily abutting or within the image.” (To clarify: “content displayed proximate to an image,” also includes “content displayed abutting or within the image.”) In another example, “content displayed proximate to an image,” means “content displayed on the same screen page or web page as the image.”

Publisher: Party that owns, provides, and/or controls a digital content platform; or third-party charged with providing, maintaining, and/or controlling ad space on a digital content platform.

Before the present invention is described in greater detail, it is to be understood that this invention is not limited to particular embodiments described, and as such may vary. It is also to be understood that the terminology used herein is for the purpose of describing particular embodiments only, and is not intended to be limiting. The scope of the present invention will be limited only by the appended claims.

### DETAILED DESCRIPTION

The present invention generally relates to computer-implemented systems and methods for presenting and/or browsing images on a digital content platform. In one embodiment, for example, there is provided an image-browsing system, including: (1) a database having a plurality of images; (2) an image frame provided on the digital content platform, wherein the image frame displays a first image from the database; and (3) a user-actionable interface, wherein activation of the interface replaces the first image within the frame with a second image. Various alternative aspects and embodiments are further described herein. For example, in certain instances, such systems and methods may be used to browse images on a digital content platform (e.g., a web page), conduct image searches directly from an image frame within a digital content platform, and/or provide contextually relevant advertising on the digital content platform.

The following detailed description of the figures refers to the accompanying drawings that illustrate exemplary embodiments. Other embodiments are possible. Modifications may be made to the embodiments described herein without departing from the spirit and scope of the present invention. Therefore, the following detailed description is not meant to be limiting.

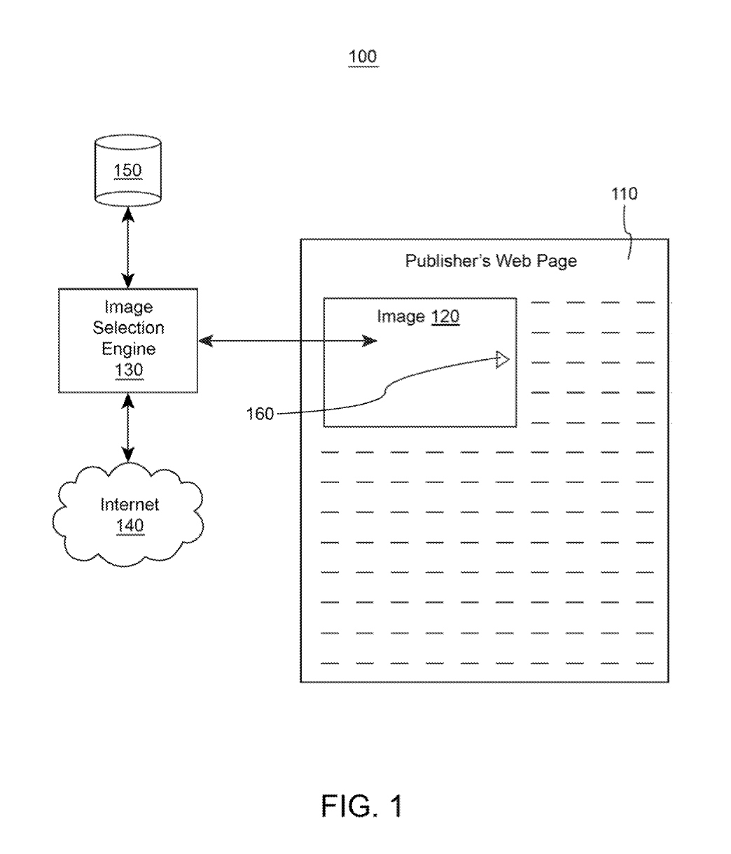

FIG. 1 is a high-level diagram illustrating an embodiment of the present invention. More specifically, FIG. 1 shows a computer-implemented system 100 for presenting and/or browsing images on a digital content platform, such as a publisher's web page 110. For the sake of simplicity, certain aspects and/or components of the presented system are not shown. For example, as would be understood by one of skill in the art, web page 110 is typically provided within a web browser on an end-user's device. The end-user's device (e.g., computer, tablet, mobile phone, etc.) is then connected (wired or wirelessly) to a network (e.g., the Internet) to transmit data, files, instructions, etc.

Web page 110 may include content, such as text (shown in phantom) and at least one image 120. In practice, image 120 is displayed within an image frame on web page 110. In some instances, the systems and methods presented herein allow a user to activate a user-actionable interface (such as interface 160) to browse between different images within the image frame. In certain embodiments, the different images browsed within the image frame may be contextually relevant to the original image 120, or any digital content on web page 110. Further, in certain embodiments, images browsed within the image frame may include contextually relevant advertisements serving as hyperlinks to a merchant or third-party website.

An image selection engine 130 is implemented to identify the context of image 120 and/or any digital content on web page 110. Image selection engine 130 may then be used to replace image 120 with a selected second image, upon activation by an end user. Preferably, the second image is contextually relevant to image 120 and/or any digital content on web page 110. For example, image selection engine 130 may receive (via push or pull implementation) replacement images from an Internet search 140 and/or image database 150. In other words, when a user activates interface 160, image selection engine 130 replaces image 120 with a second image, which may have been received from an Internet search 140, image database 150, and/or any equivalents or combinations thereof.

The second image is preferably associated with, related to, or otherwise relevant to image 120 and/or the digital content on web page 110. As such, a user can browser amongst related images within the image frame, without having to affect, change, or depart from the digital content of web page 110. The user can also browse amongst related images within the image frame without having to be redirected to a second web page. If, however, the user is interested in viewing a second web page (e.g., a second web page wherein the replacement image originated), the user can then activate (e.g., click) the replacement image and be redirected via a hyperlink.

Image selection engine 130 may be incorporated into the web browser, the source code of the web page 110, or be a system component external to the web browser. Image selection engine 130 may be controlled by a merchant, a publisher, a third-party service provider, and/or any equivalents or combinations thereof. In alternative embodiments, image selection engine 130 may include a crowdsourcing network, an image-recognition system, text-recognition system, and/or any equivalents or combinations thereof. In one embodiment, image selection engine 130 includes the systems and methods described in U.S. application Ser. No. 13/005,217, which was incorporated by reference above.

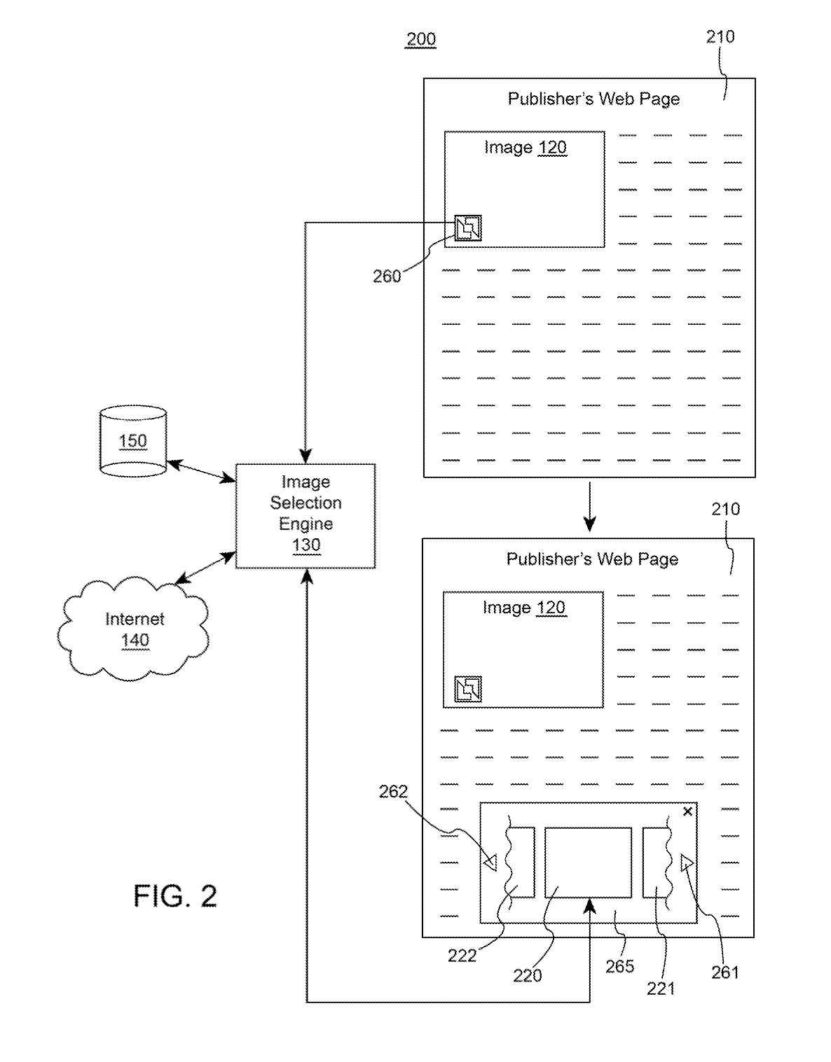

FIG. 2 is a high-level diagram illustrating another embodiment of the present invention. More specifically, FIG. 2 shows a computer-implemented system 200 for presenting and/or browsing images on a digital content platform, such as a publisher's web page 210. (Again, for the sake of simplicity, certain aspects and/or components of the presented system are not shown.) Web page 210 may include digital content, such as text (shown in phantom) and at least one image 120. In practice, image 120 is displayed within an image frame on web page 210. In some instances, the systems and methods presented herein allow a user to activate a first user-actionable interface (e.g., interface or hotspot 260), which activates an image-browsing image frame 265. Within image frame 265, a user can use a second user-actionable interface (e.g., activation buttons 261, 262) to browse between different images 220, 221, 222 within image frame 265. In certain embodiments, the different images browsed within image frame 265 may be contextually relevant to each other, to original image 120, to digital content on web page 210, or may provide contextually relevant advertisements serving as hyperlinks to a merchant or third-party website. As would be understood by one of skill in the art, any user-actionable interface (including hotspot 260) may be provided (or otherwise programmed) to allow a user to browser between images in image frame 265. In other words, although the description (and in certain cases the claims below) call for a first and second user-actionable interfaces, said first and second user-actionable interfaces may in fact be a single interface performing first and second functions.

In practice, a user can activate hotspot 260 by, for example, a mouse-over of the hotspot. Image frame 265 is then displayed on web page 210. As described above with respect to FIG. 1, an image selection engine 130 is implemented in order to select and provide images 220, 221, and 222. In one embodiment, images 220, 221, and 222 are contextually related to each other, to image 120, and/or to digital content on web page 210. Image frame 265 may be used as a means to browse images on web page 210, without having to leave web page 210. Further, each image within image frame 265 may provide a link to another web page, such as a merchant's web page. As such, image frame 265 may provide a means for displaying advertisements that are contextually relevant to image 120, digital content on web page 210, and/or other images displayed within image frame 265.

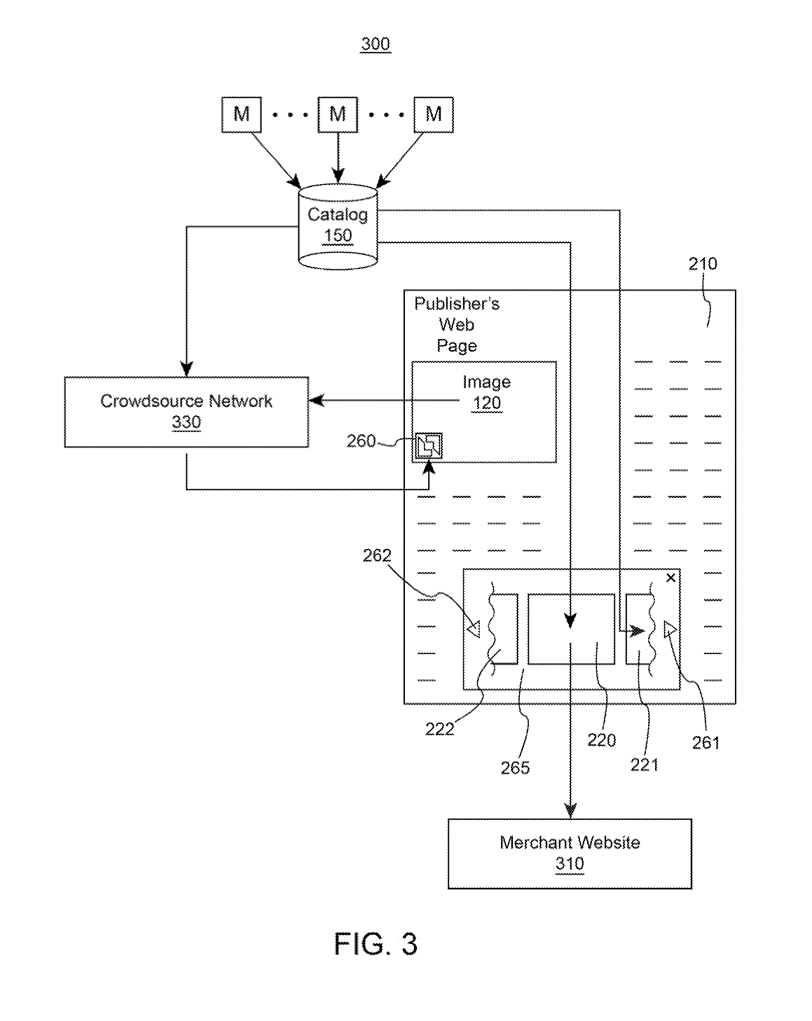

FIG. 3 is a high-level diagram illustrating yet another embodiment of the present invention. More specifically, FIG. 3 shows a schematic implementation of the system described in FIG. 2. In FIG. 3, image database 150 comprises a catalog of a plurality of images received from a plurality of merchants (M). For example, each merchant may provide one or more images related to their product line. Each image may include one or more contextual tags to identify, categorize, catalog, and/or otherwise organize the images into database 150. In one embodiment, images within database 150 are indexed based on their individual contextual tag(s), and may be indexed to form at least one array of contextually relevant images, or to form a two-dimensional array of contextually relevant images. The contextual tag(s) may be selected from the group consisting of: people (e.g., celebrities, athletes, politicians); places (e.g., cities, venues, monuments, general geo-coordinates); events (e.g., Emmy Awards, Super Bowl, celebrity parties); classes of objects (e.g., sport cars, apparel); specific products (e.g., brand name products); abstract concepts (e.g., “winning,” “happy couples,” “family life”); photographic genres (e.g., portraits, scenery); and/or any combinations or equivalents thereof. Contextual tags may also be used to exclude matching images from being shown (e.g., images of pornography, weapons, crime, etc.).

In FIG. 3, the function of image selection engine 130 is performed by a crowdsource network 330, which may include one or more individuals delegated with the task of selecting images to display on web page 210 (and more specifically on image frame 265). In one embodiment, an interface (e.g., a user interface or application programming interface, not shown) is provided such that crowdsource network 330 can view, identify, and/or tag image 120 and/or digital content on web page 210. Crowdsource network 330 is also provided access to database 150 (e.g., via a user interface or application programming interface, not shown). As such, crowdsource network 330 may identify, tag, and match image 120 with images within database 150. In one embodiment, the crowdsourcing interface(s) may aggregate data-feeds from a plurality of merchants into database 150 with a plurality of products. The crowdsourcing interface(s) may also manages a queue of images from one or more web pages, and provide full text search and other tools to find matching products.

FIG. 3 also provides the general framework for a method of image-browsing and/or providing contextually relevant advertisements on a digital platform, such as a web page. In one embodiment, for example, there is provided a method for providing contextually relevant advertisements, which begins with creating an image catalog populated with a plurality of product images from a plurality of merchants. Each image in the image catalog may include one or more contextual tags, which allows for identifying, indexing, categorizing, organizing, searching, or otherwise manipulating the images in the catalog. The images may also be organized in one or two-dimensional arrays based on contextual tag(s). Each image within the catalog may also include a hyperlink to a web page (or site) belonging to the merchant or otherwise providing more information about the contents of the image.

After the catalog is created, access to the catalog is provided to the crowdsource network via a user (or application programming) interface. An user (or application programming) interface is also provided to the crowdsource network to (1) identify a published image 120 on a publisher's web page 210, (2) tag the published image 120 with a contextual tag, and (3) match the published image 120 with at least one matching product image from the image catalog 150.

A first user-actionable interface 260 is provided on web page 210 for a user to activate the published image 120. Upon activation by the user, an image frame 265 is provided on the web page 210 to display one or more matching product images 220, 221, 222. The image frame also include second user-actionable interface(s) 261, 262. Activation of one of the second user-actionable interface(s) 261, 262 replaces the matching product image 220, within the image frame, with a second image 221 or 222. Each image may then provide a hyperlink to a respective merchant's website 310.

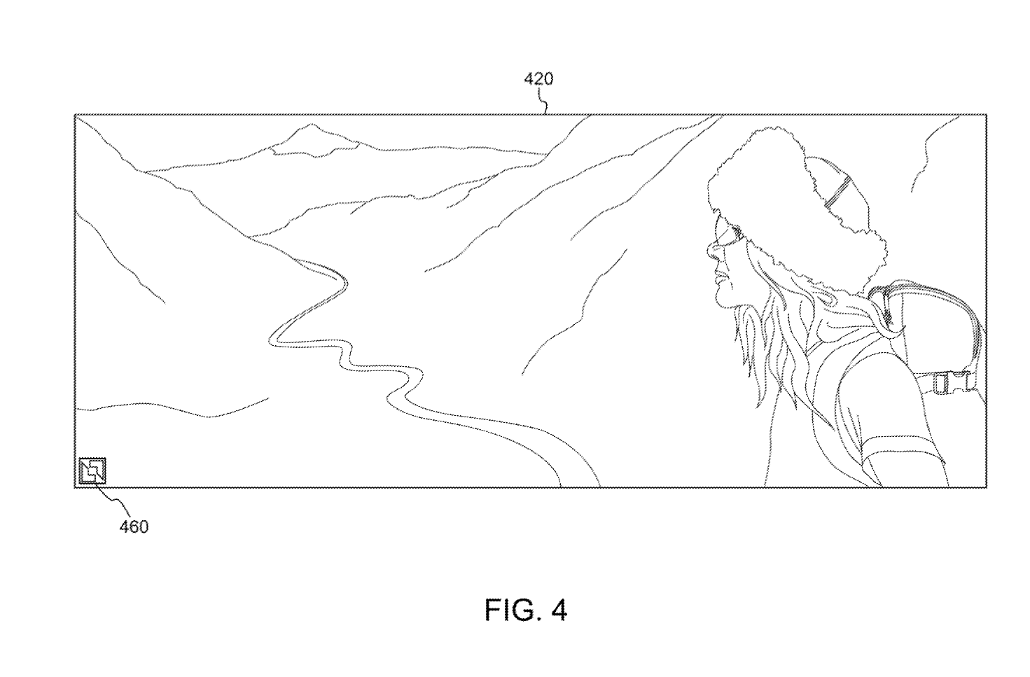

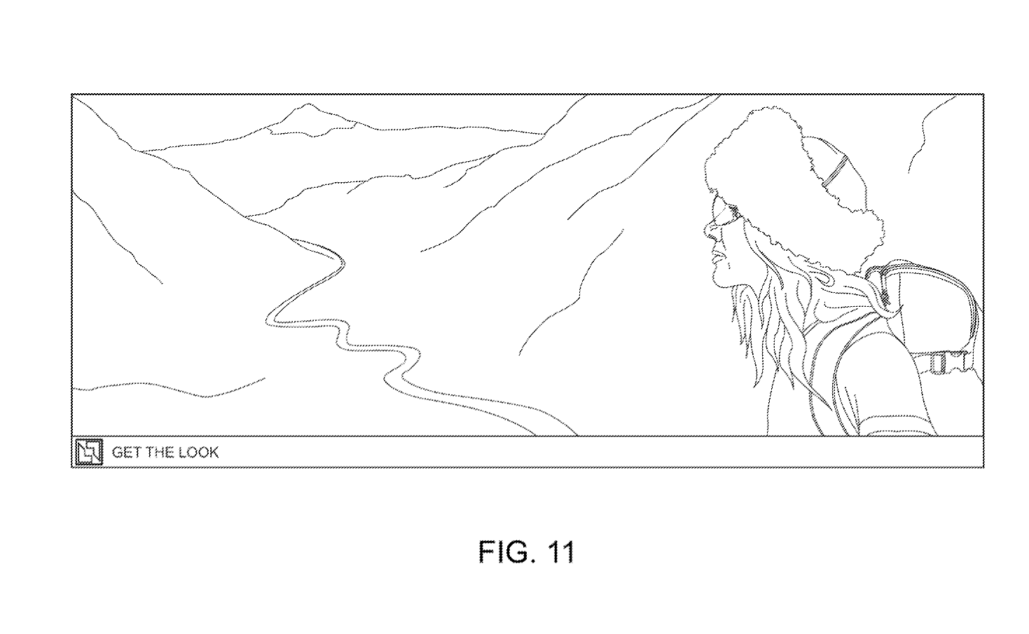

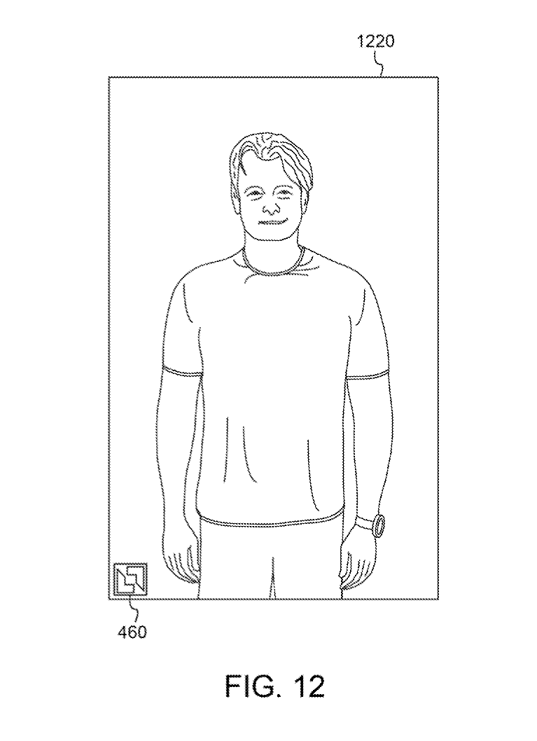

FIGS. 4-14 show screen-shots of a web-based system in accordance with one embodiment presented. More specifically, FIG. 4 shows an image 420, published on a web page. Image 420 also includes a user-actionable interface (or hotspot) 460. As can be seen from FIG. 4, the context of image 420 includes a hiker on a mountain trail. FIG. 11 is a screen-shot of another embodiment of a hotspot and user-actionable interface. FIG. 12 provides another screen-shot, showing a different image 1220, with a similar hotspot 460 implementation.

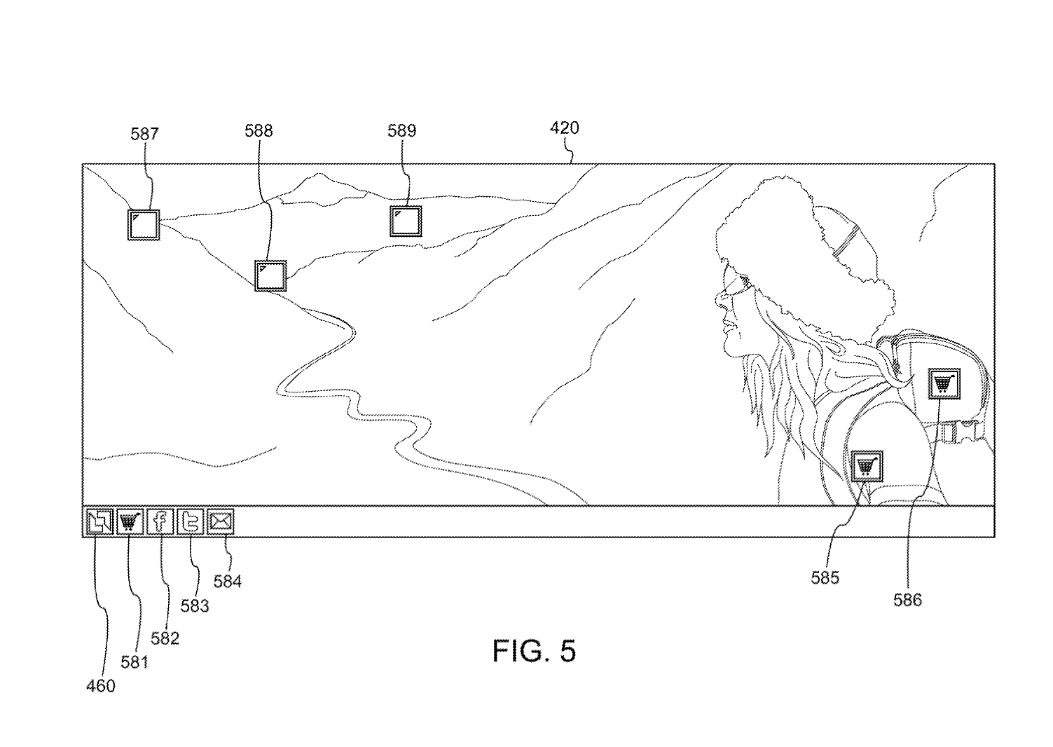

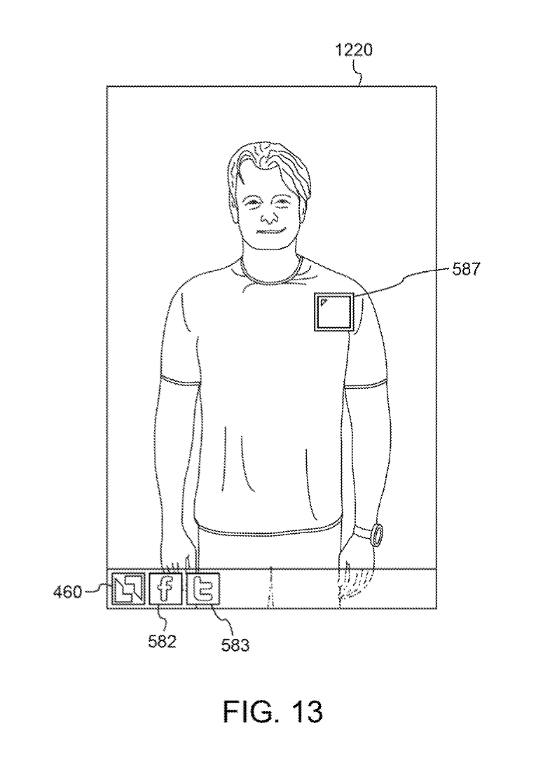

In FIG. 5, hotspot 460 has been activated to show a plurality of optional application buttons 581-589, which allow a user to interact with the published image. Buttons 581, 585, and 586 are shopping cart buttons, and would indicate to a user that clicking said buttons would provide the user with an opportunity to purchase (or be directed to a site for purchasing) products related to image 420. Buttons 587, 588, and 589 are informational buttons and would indicate to the user that clicking said buttons would provide information about the context/contents of the image around the button. Buttons 582, 583, and 584 are share buttons, and would indicate to the user that the entirety of, or portions of, the image can be shared on a social network (e.g., Facebook™ Twitter™) or via e-mail. FIG. 13 shows similar icons, which appear after the user has activated hotspot 460.

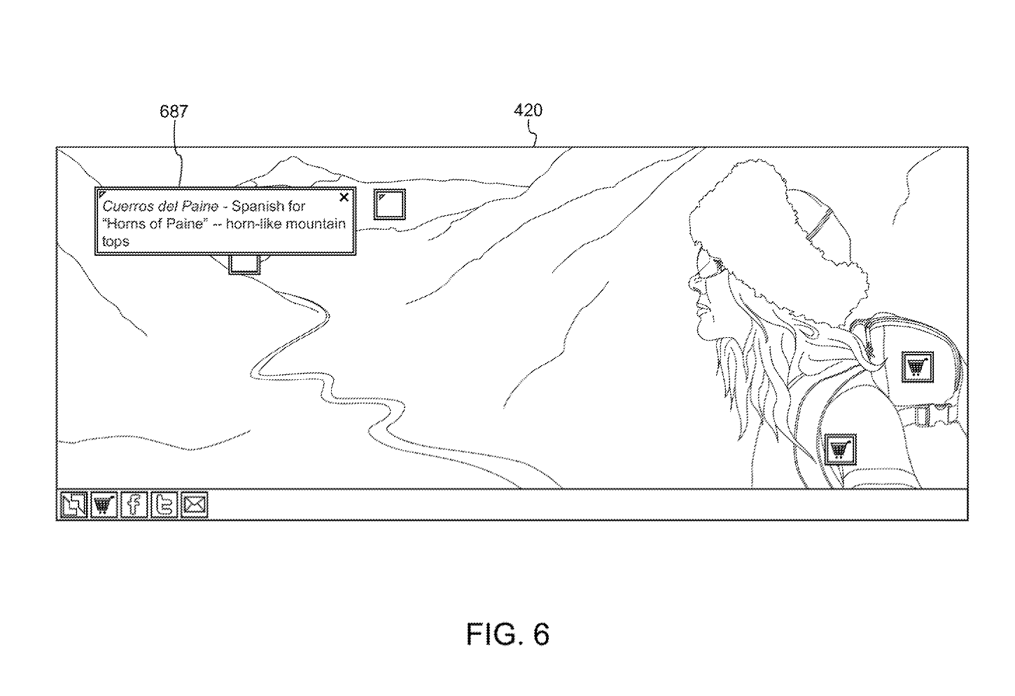

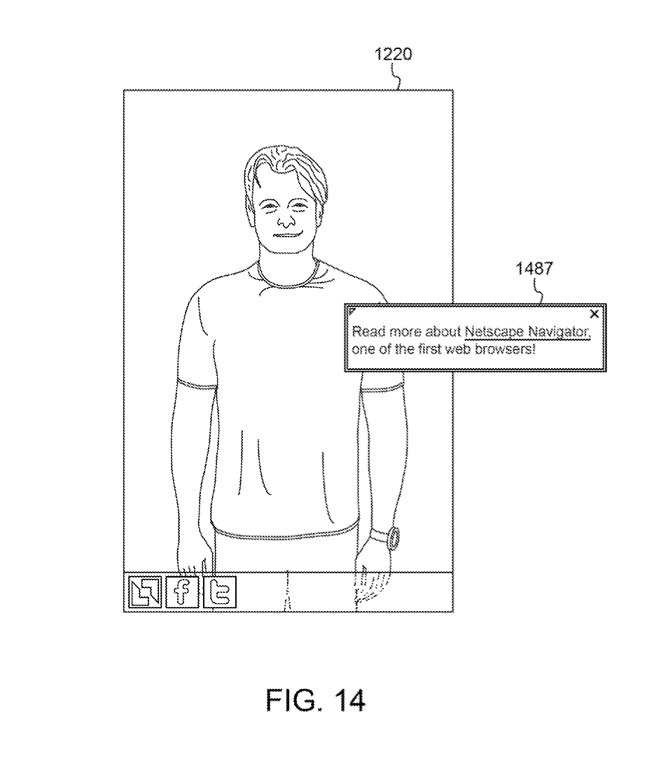

FIG. 6 shows what happens when a user activates application button 587. As shown in FIG. 6, activation of button 587 presents a dialog box 687 with digital content (e.g., text) relevant to the context of image 420. In the example shown, dialog box 687 has text explaining the subject matter shown in image 420 proximate to button 587. The text within dialog box 687 may be created by the publisher or by a crowdsourcing network. Also, image 420 may be tagged with application button 587 by the publisher or a crowdsourcing network. FIG. 14 shows a similar dialog box 1487.

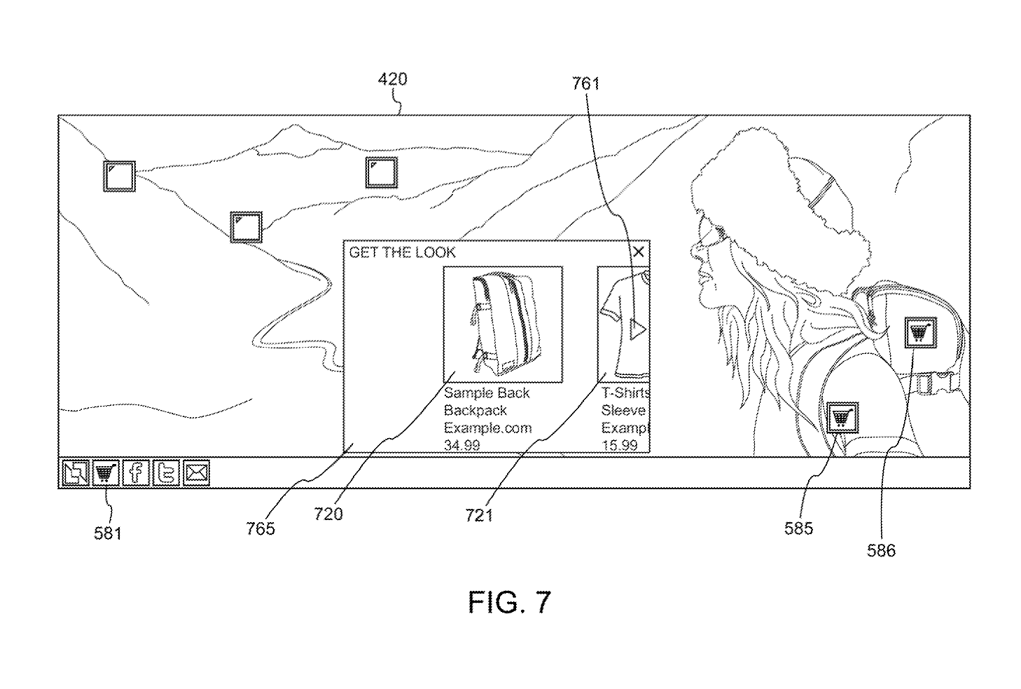

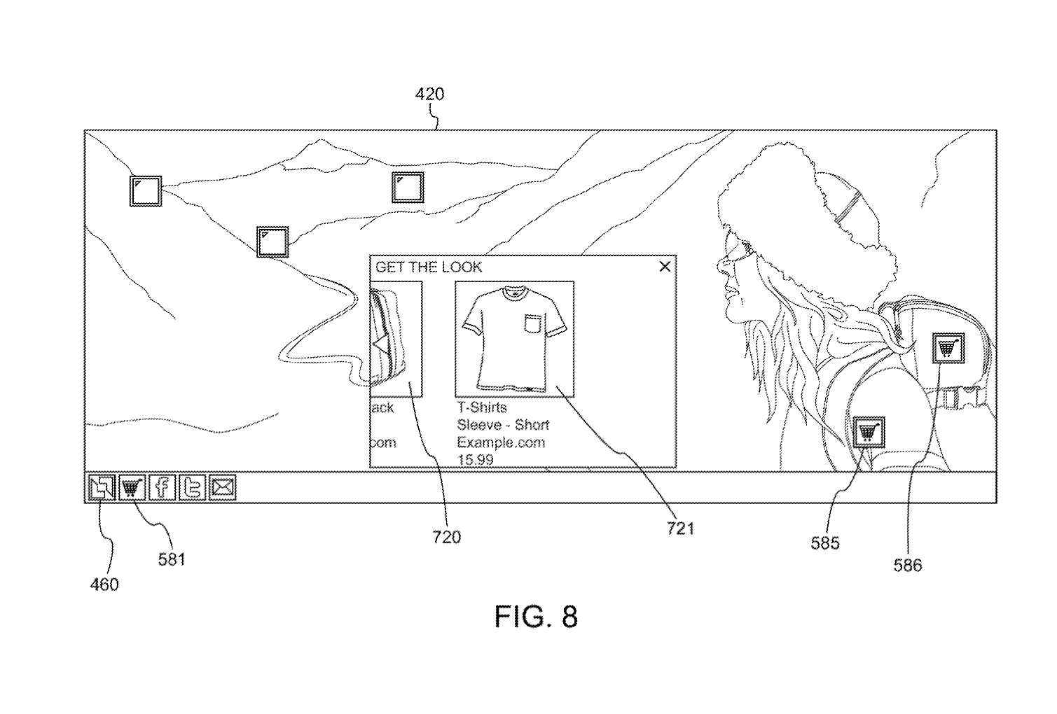

FIGS. 7 and 8 show what happens when a user activates an application button, such as one of the shopping cart buttons 581, 585, or 586. Upon a user's activation of shopping cart buttons 581, 585, or 586, an image frame 765 is provided proximate image 420. A first image 720 is provided within image frame 765. The first image 720 may be selected by an automated or semi-automated image selection engine. In one embodiment, a crowdsourcing network is provided with an interface to access/view published image 420. The crowdsourcing network can then identify that the context of the image includes a hiker on a mountain trail. The crowdsourcing network can then tag products within the image, such as the hiker's backpack and/or shirt. The crowdsourcing network can then access an image database with a catalog of merchant products. The crowdsourcing network would then select images that are relevant (or otherwise match) the context of image 420; e.g., an image 720 of a backpack and/or an image 721 of a shirt. Said first and second images 720, 721 can be displayed within image frame 765, browsed via interface 761, and clicked on to provide a link to a merchant's website where the user can purchase the shown backpack and/or shirt.

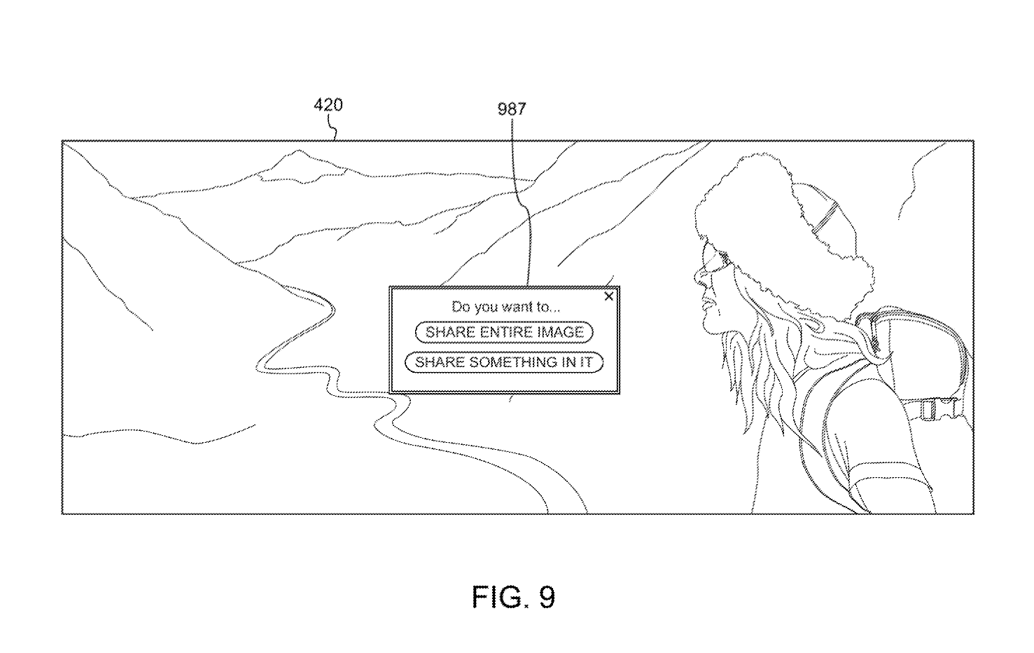

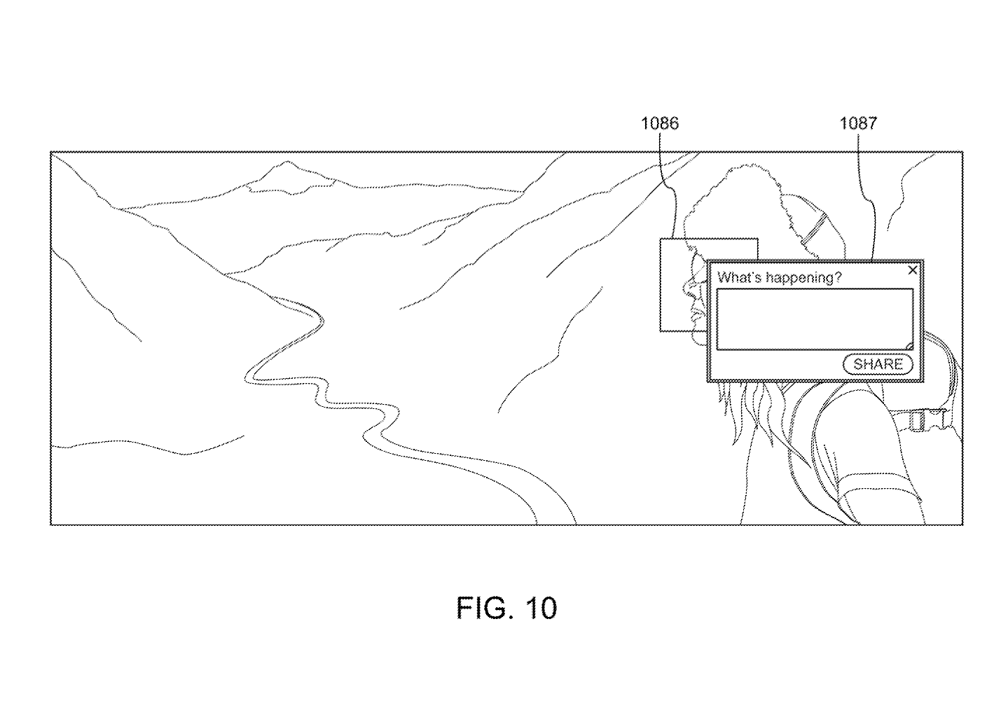

FIGS. 9 and 10 are screen-shots of another embodiment presented. FIGS. 9 and 10 show a “share” function provided when a user clicks on one of the application buttons 582, 583, or 584 of FIG. 5. The share function shown in FIGS. 9 and 10 are described in co-pending U.S. application Ser. No. 13/219,460, which was incorporated by reference above. For example, when a user clicks on one of the application buttons 582, 583, or 584 of FIG. 5, a dialog box 987 appears on the screen. A user is then prompted to pick whether the user wishes to share the entire image 420, or a portion of the image 420. If the user choses to share only a portion of the image, a selection box 1086 is provided to the user in order for the user to select the portion of the image that the user wishes to share. When the user selects the portion of the image that they wish to share, another dialog box 1087 is provided for the user to comment on the portion of the image being shared. The text entered by the user is then linked to the selected portion of the image, and is shared in accordance with the systems and methods described in U.S. application Ser. No. 13/219,460.

### Additional Embodiments

In one embodiment, there is provided an image-browsing system for displaying images on a digital content platform. The system includes: (1) a database having a plurality of images, each image having at least one contextual tag; (2) an image frame provided on a digital content platform, wherein the image frame displays a first image provided from the plurality of images in the database; and (3) a user-actionable interface, wherein activation of the user-actionable interface replaces the first image within the frame with a second image. The image frame may be provided in a fixed position on the digital content platform, or appear upon a user's activation of a hotspot on the digital content platform.

The second image may be provided from the plurality of images in the database, or from an Internet search result based on the contextual tag of the first image. The second image may include a contextual tag that matches a contextual tag of the first image. In one embodiment, a portion of the second image is displayed within the image frame adjacent to the first image. The first and/or second image may provide a hyperlink to a third-party website.

In one embodiment, a contextual tag of the first image matches a contextual tag attached to content surrounding the image frame on the digital content platform. The contextual tag of the second image may match a contextual tag attached to content surrounding the image frame on the digital content platform. The content surrounding the image frame on the digital content platform may be selected from the group consisting of: an image, text, and a video. The content surrounding the image frame may be provided by a crowdsource network, an image-recognition program, or a text-recognition program.

Further, the plurality of images in the database may be indexed based on their individual contextual tag. For example, the plurality of images in the database may be indexed based on their individual contextual tag to form at least one array of contextually relevant images, or to form a two-dimensional array of contextually relevant images. The contextual tag may be selected from the group consisting of: people, events, classes of objects, specific products, abstract concepts, photographic genres, and/or any combinations or equivalents thereof.

In another embodiment, there is provided a computer-implement method for providing a web-based image-browsing system. The method includes: (a) creating an image catalog populated with a plurality of product images from a plurality of merchants; and (b) indexing the plurality of product images in the image catalog such that each product image is indexed with at least one contextual tag. The method further includes: (c) providing an interface for a crowdsource network to (1) identify a published image on a web page of a publisher's website, and (2) tag the published image with a contextual tag. The method further includes: (d) matching the published image with a product image from the image catalog based on their respective contextual tag; (e) providing a first user-actionable interface on the web page of the publisher's website for a user to activate the published image; and (f) upon activation by the user, providing an image frame on the web page. The image frame displays the matching product image of step (d). The image frame includes a second user-actionable interface such that activation of the second user-actionable interface replaces the matching product image of step (d) within the image frame with a second image from the image catalog. The second image is selected based on at least one contextual tag associated with the published image.

In yet another embodiment, there is provided a computer-implement method for providing a web-based image-browsing system. The method comprises: (a) creating an image catalog populated with a plurality of product images from a plurality of merchants; (b) indexing the plurality of product images in the image catalog such that each product image is indexed with at least one contextual tag; (c) providing an interface for a crowdsource network to (1) identify a published image on a web page of a publisher's website, and (2) tag the published image with a contextual tag; (d) matching the published image with a first product image from the image catalog based on a first contextual tag; (e) matching the published image with a second product image from the image catalog based on a second contextual tag; (f) providing a first user-actionable interface on the web page of the publisher's website for a user to activate the published image, where upon activation by the user of the first user-actionable interface, an image frame is provided on the web page, and wherein the image frame displays the first product image of step (d); and (g) providing a second user-actionable interface such that activation of the second user-actionable interface replaces the first product image of step (d) within the image frame with the second product image of step (e).

In still another embodiment, there is provided a method comprising: (a) creating an image catalog populated with a plurality of product images from a plurality of merchants; (b) providing an interface for a crowdsource network to (1) identify a published image on a web page of a publisher's website, (2) tag the published image with a contextual tag, and (3) match the published image with at least one matching product image from the image catalog; (c) providing a first user-actionable interface on the web page of the publisher's website for a user to activate the published image; and (d) upon activation by the user, providing an image frame on the web page, wherein the image frame displays the matching product image of step (b)(3), and wherein the image frame includes a second user-actionable interface, wherein activation of the second user-actionable interface replaces the matching product image of step (b)(3) within the image frame with a second image. A portion of the second image may be displayed within the image frame adjacent to the matching product image of step (b)(3).

The second image may be provided from the image catalog. Each product image in the image catalog may include at least one contextual tag, and wherein the second image includes a contextual tag that matches a contextual tag of the matching product image of step (b)(3).

The matching product image of step (b)(3) may include a contextual tag, and the method may further comprise: (e) conducting an Internet image search based on the contextual tag of the matching product image of step (b)(3); (f) selecting the second image from results of the Internet image search; (g) indexing the plurality of product images in the image catalog are indexed based on at least one contextual tag; (h) indexing the plurality of product images to form at least one array of contextually relevant images; and/or (i) indexing the plurality of product images to form a two-dimensional array of contextually relevant images. The contextual tag may be selected from the group consisting of: people, events, classes of objects, specific products, abstract concepts, photographic genres, and/or any combinations or equivalents thereof.

The method may be used for providing contextually relevant advertising on a web page of a publisher's website. The matching product image of step (b)(3), and/or the second image, may provide a hyperlink to a third-party and/or merchant's website. A contextual tag of the matching product image of step (b)(3) may match a contextual tag attached to content surrounding the image frame on the website. A contextual tag of the second image may match a contextual tag attached to content surrounding the image frame on the website. The content surrounding the image frame on the website may be selected from the group consisting of: an image, text, and a video. The contextual tag attached to the content surrounding the image frame may be provided by the crowdsource network, an image-recognition program, or a text-recognition program.

In one embodiment, there is provided a computer-readable storage medium for providing a web-based image-browsing system for displaying images on a web browser. the storage medium includes: (1) a database having a plurality of images, each image having at least one contextual tag; and (2) instructions executable by at least one processing device that, when executed, cause the processing device to (a) provide an image frame on a website, wherein the image frame displays a first image provided from the plurality of images in the database, (b) provide a user-actionable interface, and (c) replace the first image within the frame with a second image, upon activation of the user-actionable interface.

In still another embodiment, there is provided a web-based system for providing contextually relevant advertising, comprising: (a) an image catalog populated with a plurality of product images from a plurality of merchants; (b) an interface for a crowdsource network to (1) identify a published image on a web page of a publisher's website, (2) tag the published image with a contextual tag, and (3) match the published image with at least one matching product image from the image catalog; (c) a first user-actionable interface on the web page of the publisher's website for a user to activate the published image; (d) an image frame on the web page, which appears upon activation by the user of the first user-actionable interface, wherein the image frame displays the matching product image; and (e) a second user-actionable interface, wherein activation of the second user-actionable interface replaces the matching product image within the image frame with a second image.

### Communication Between Parties Practicing the Present Invention

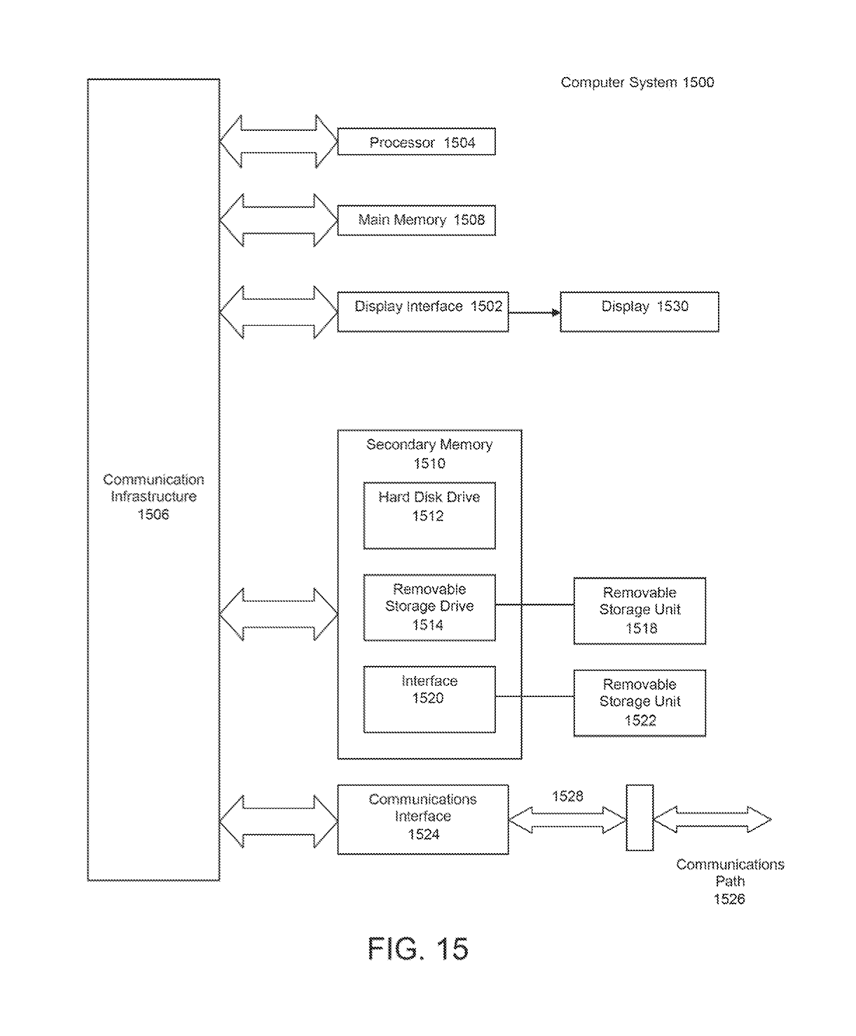

In one embodiment, communication between the various parties and components of the present invention is accomplished over a network consisting of electronic devices connected either physically or wirelessly, wherein digital information is transmitted from one device to another. Such devices (e.g., end-user devices and/or servers) may include, but are not limited to: a desktop computer, a laptop computer, a handheld device or PDA, a cellular telephone, a set top box, an Internet appliance, an Internet TV system, a mobile device or tablet, or systems equivalent thereto. Exemplary networks include a Local Area Network, a Wide Area Network, an organizational intranet, the Internet, or networks equivalent thereto. The functionality and system components of an exemplary computer and network are further explained in conjunction with FIG. 15, below.

### Computer Implementation

In one embodiment, the invention is directed toward one or more computer systems capable of carrying out the functionality described herein. For example, FIG. 15 is a schematic drawing of a computer system 1500 used to implement the methods presented above. Computer system 1500 includes one or more processors, such as processor 1504. The processor 1504 is connected to a communication infrastructure 1506 (e.g., a communications bus, cross-over bar, or network). Computer system 1500 can include a display interface 1502 that forwards graphics, text, and other data from the communication infrastructure 1506 (or from a frame buffer not shown) for display on a local or remote display unit 1530.

Computer system 1500 also includes a main memory 1508, such as random access memory (RAM), and may also include a secondary memory 1510. The secondary memory 1510 may include, for example, a hard disk drive 1512 and/or a removable storage drive 1514, representing a floppy disk drive, a magnetic tape drive, an optical disk drive, flash memory device, etc. The removable storage drive 1514 reads from and/or writes to a removable storage unit 1518. Removable storage unit 1518 represents a floppy disk, magnetic tape, optical disk, flash memory device, etc., which is read by and written to by removable storage drive 1514. As will be appreciated, the removable storage unit 1518 includes a computer usable storage medium having stored therein computer software, instructions, and/or data.

In alternative embodiments, secondary memory 1510 may include other similar devices for allowing computer programs or other instructions to be loaded into computer system 1500. Such devices may include, for example, a removable storage unit 1522 and an interface 1520. Examples of such may include a program cartridge and cartridge interface (such as that found in video game devices), a removable memory chip (such as an erasable programmable read only memory (EPROM), or programmable read only memory (PROM)) and associated socket, and other removable storage units 1522 and interfaces 1520, which allow computer software, instructions, and/or data to be transferred from the removable storage unit 1522 to computer system 1500.

Computer system 1500 may also include a communications interface 1524. Communications interface 1524 allows computer software, instructions, and/or data to be transferred between computer system 1500 and external devices. Examples of communications interface 1524 may include a modem, a network interface (such as an Ethernet card), a communications port, a Personal Computer Memory Card International Association (PCMCIA) slot and card, etc. Software and data transferred via communications interface 1524 are in the form of signals 1528 which may be electronic, electromagnetic, optical or other signals capable of being received by communications interface 1524. These signals 1528 are provided to communications interface 1524 via a communications path (e.g., channel) 1526. This channel 1526 carries signals 1528 and may be implemented using wire or cable, fiber optics, a telephone line, a cellular link, a radio frequency (RF) link, a wireless communication link, and other communications channels.

In this document, the terms “computer-readable storage medium,” “computer program medium,” and “computer usable medium” are used to generally refer to media such as removable storage drive 1514, removable storage units 1518, 1522, data transmitted via communications interface 1524, and/or a hard disk installed in hard disk drive 1512. These computer program products provide computer software, instructions, and/or data to computer system 1500. These computer program products also serve to transform a general purpose computer into a special purpose computer programmed to perform particular functions, pursuant to instructions from the computer program products/software. Embodiments of the present invention are directed to such computer program products.

Computer programs (also referred to as computer control logic) are stored in main memory 1508 and/or secondary memory 1510. Computer programs may also be received via communications interface 1524. Such computer programs, when executed, enable the computer system 1500 to perform the features of the present invention, as discussed herein. In particular, the computer programs, when executed, enable the processor 1504 to perform the features of the presented methods. Accordingly, such computer programs represent controllers of the computer system 1500. Where appropriate, the processor 1504, associated components, and equivalent systems and sub-systems thus serve as “means for” performing selected operations and functions. Such “means for” performing selected operations and functions also serve to transform a general purpose computer into a special purpose computer programmed to perform said selected operations and functions.

In an embodiment where the invention is implemented using software, the software may be stored in a computer program product and loaded into computer system 1500 using removable storage drive 1514, interface 1520, hard drive 1512, communications interface 1524, or equivalents thereof. The control logic (software), when executed by the processor 1504, causes the processor 1504 to perform the functions and methods described herein.

In another embodiment, the methods are implemented primarily in hardware using, for example, hardware components such as application specific integrated circuits (ASICs) Implementation of the hardware state machine so as to perform the functions and methods described herein will be apparent to persons skilled in the relevant art(s). In yet another embodiment, the methods are implemented using a combination of both hardware and software.

Embodiments of the invention, including any systems and methods described herein, may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

For example, in one embodiment, there is provided a computer-readable storage medium, having instructions executable by at least one processing device that, when executed, cause the processing device to: (a) provide an image frame on a website, wherein the image frame displays a first image provided from the plurality of images in the database, (b) provide a user-actionable interface, and (c) replace the first image within the frame with a second image, upon activation of the user-actionable interface.

In another example, there is provided a computer-readable storage medium comprising instructions executable by at least one processing device that, when executed, cause the processing device to (a) create an image catalog populated with a plurality of product images from a plurality of merchants; (b) provide an interface for a crowdsource network to (1) identify a published image on a web page of a publisher's website, (2) tag the published image with a contextual tag, and (3) match the published image with at least one matching product image from the image catalog; (c) provide a first user-actionable interface on the web page of the publisher's website for a user to activate the published image; and (d) upon activation by the user, provide an image frame on the web page. The image frame displays the matching product image, and the image frame includes a second user-actionable interface. Activation of the second user-actionable interface replaces the matching product image within the image frame with a second image. A portion of the second image may be displayed within the image frame adjacent to the matching product image.

### CONCLUSION

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

1. A computer-implement method for providing a web-based image-browsing system, the method comprising:
(a) creating an image catalog populated with a plurality of product images from a plurality of merchants;
(b) indexing the plurality of product images in the image catalog such that each product image is indexed with at least one contextual tag;
(c) providing an interface for a crowdsource network to (1) identify objects within a published image on a web page of a publisher's website, and (2tag the objects within the published image with one or more contextual tags;
(d) matching a first object within the published image with a first product image from the image catalog based on a first contextual tag;
(e) matching a second object within the published image with a second product image from the image catalog based on a second contextual tag;
(f) providing a first user-actionable interface on the web page of the publisher's website for a user to activate the published image, wherein the first user-actionable interface is proximate the first object within the published image, and where upon activation by the user of the first user-actionable interface, an image frame is provided on the web page, and wherein the image frame displays the first product image of step (d); and
(g) providing a second user-actionable interface within the published image, wherein the second user-actionable interface is proximate the second object within the published image, such that activation of the second user-actionable interface replaces the first product image of step (d) within the image frame with the second product image of step (e).

2. An image-browsing system for selecting and displaying a plurality of contextually relevant images proximate to a published image on a digital content platform, comprising:
a server, including a memory unit for storing a database having a plurality of images, each image having at least one contextual tag; and
a processor configured to provide:
an image frame proximate to the published image on the digital content platform, wherein the image frame displays a first image provided from the plurality of images in the database, and
a user-actionable interface within the published image and proximate to an object within the published image, wherein activation of the user-actionable interface replaces the first image within the frame with a second image, and wherein the second image is selected based on the object within the published image.

3. The system of claim 2, wherein the second image is selected from the plurality of images in the database.

4. The system of claim 3, wherein the second image includes a contextual tag that matches a contextual tag of the first image.

5. The system of claim 2, wherein a portion of the second image is displayed within the image frame adjacent to the first image.

6. The system of claim 2, wherein the second image is provided by an Internet search result based on the contextual tag of the first image.

7. The system of claim 2, wherein the plurality of images in the database are indexed based on their individual contextual tag.

8. The system of claim 2, wherein the plurality of images in the database are indexed based on their individual contextual tag to form at least one array of contextually relevant images.

9. The system of claim 2, wherein the plurality of images in the database are indexed based on their individual contextual tag to form a two-dimensional array of contextually relevant images.

10. The system of claim 2, wherein the contextual tag is selected from the group consisting of: people, events, classes of objects, specific products, abstract concepts, photographic genres, and any combinations thereof.

11. The system of claim 2, wherein the first image provides a hyperlink to a third-party website.

12. The system of claim 2, wherein the second image provides a hyperlink to a third-party website.

13. The system of claim 2, wherein a contextual tag of the first image matches a contextual tag attached to content surrounding the image frame on the digital content platform.

14. The system of claim 13, wherein the content surrounding the image frame on the digital content platform is selected from the group consisting of: an image, text, and a video.

15. The system of claim 13, wherein the contextual tag attached to the content surrounding the image frame is provided by a crowdsource network, an image-recognition program, or a text-recognition program.

16. The system of claim 2, wherein a contextual tag of the second image matches a contextual tag attached to content surrounding the image frame on the digital content platform.

17. The system of claim 16, wherein the content surrounding the image frame on the digital content platform is selected from the group consisting of: an image, text, and a video.

18. The system of claim 17, wherein the contextual tag attached to the content surrounding the image frame is provided by a crowdsource network, an image-recognition program, or a text-recognition program.

19. A computer-implemented method for matching objects within a published image, on a web page of a publisher's website, with contextually relevant content, the method comprising:
(a) creating an image catalog populated with a plurality of product images from a plurality of merchants;
(b) establishing a link between the publisher's website and an image analysis engine to receive the image published on the publisher's website;
(c) the image analysis engine providing a computerized interface for a crowdsource network to (1) identify objects within the published image and (2match objects within the published image with matching product images from the image catalog;
(d) providing a first user-actionable interface, proximate to a first object within the published image on the web page of the publisher's website, for a user to activate the published image; and
(e) upon activation by the user, providing an image frame on the web page, wherein the image frame displays a matching product image from step (b)(2), and wherein the image frame includes a second user-actionable interface, wherein activation of the second user-actionable interface replaces the matching product image of step (b)(2within the image frame with a second image.

20. The method of claim 19, wherein the second image is provided from the image catalog.

21. The method of claim 20, wherein each product image in the image catalog includes at least one contextual tag, and wherein the second image includes a contextual tag that matches a contextual tag of the matching product image of step (b)(2).

22. The method of claim 19, wherein the matching product image of step (b)(2) includes a contextual tag, and the method further comprising:
(e) conducting an Internet image search based on the contextual tag of the matching product image of step (b)(2); and
(f) selecting the second image based on the Internet image search.

23. The method of claim 19, further comprising:
indexing the plurality of product images in the image catalog based on at least one contextual tag.

24. The method of claim 23, further comprising:
indexing the plurality of product images to form at least one array of contextually relevant images.

25. The method of claim 23, further comprising:
indexing the plurality of product images to form a two-dimensional array of contextually relevant images.

26. The method of claim 23, wherein the contextual tag is selected from the group consisting of: people, events, classes of objects, specific products, abstract concepts, photographic genres, and any combinations thereof.

27. The method of claim 19, wherein said method is used to provide contextually relevant advertising on a web page of a publisher's website.

28. The method of claim 27, wherein the matching product image of step (b)(2) provides a hyperlink to a merchant's website.

29. The method of claim 27, wherein the second image provides a hyperlink to a third-party website.

30. The method of claim 27, wherein a contextual tag of the matching product image of step (b)(2) matches a contextual tag attached to content surrounding the image frame on the website.
